(19) United States
(12) Patent Application Publication
(10) Pub. No.: US 2020/0104883 A1
(43) Pub. Date: Apr. 2, 2020

(54) Connecting consumers with brands, products and services - The concept, method and/or technology by which single individuals, groups of individuals and/or entities can use their respective contact networks to perform marketing and/or other services on behalf of 3rd party brands, product and/or service providers for a remuneration.

(71) Applicant: Esmerina Bisha, Irvine, CA (US)

(72) Inventor: Esmerina Bisha, Irvine, CA (US)

(21) Appl. No.: 16/009,487

(22) Filed: Jun. 15, 2018

(51) Int. Cl. G06Q 30/02

(52) U.S. Cl. CPC G06Q 30/0273; G06Q 30/0276; G06Q 30/0247; G06Q 30/0208

(57) ABSTRACT

The concept, method and technology that enables individuals, group of individuals and/or entities (Individuals) to participate in marketing and other programs of 3rd party brands, product and service providers (Merchants) for a remuneration. The Individuals' contact networks are an important asset that can be used to generate income and/or other forms of remuneration. The Merchants will create marketing content which based on permission levels might be modified by the Individuals. Merchants will be matched up with Individuals based on industry, demographics, locations, type of advertisement, marketing persona, etc. Individuals and Merchants are matched up by the system and the Merchants will not have access to the Individuals' details, nor will they have direct communication with Individuals. Individuals will create their contact networks in a server and will distribute or will grant permission to have the marketing content distributed to their contacts base on their behalf. An Individual's contact base includes but is not limited to: phone contacts, email contacts, social media contacts, chatting contacts, professional associations contacts, etc. The Individuals will be remunerated for providing this service.

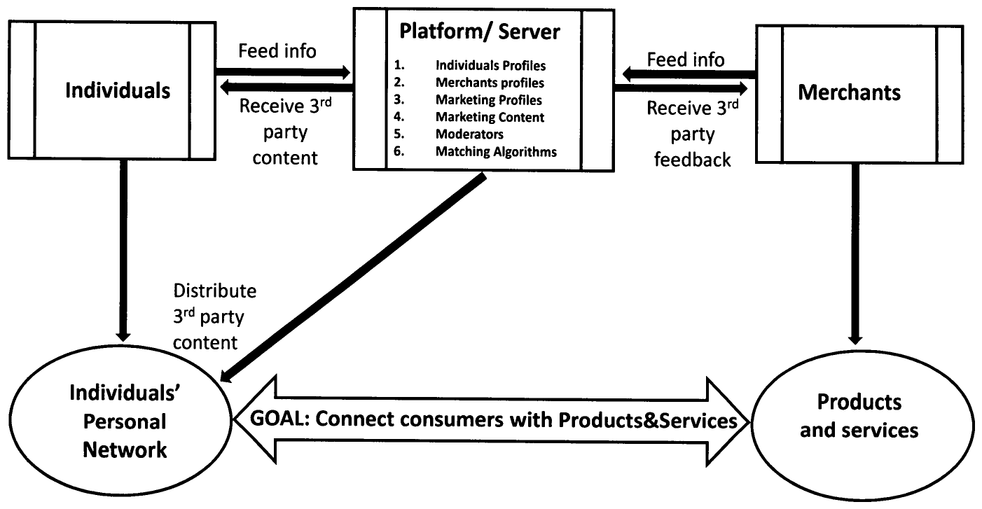

### DESCRIPTION OF THE INVENTION

Growing the business and connecting with potential customers is one of the major challenges for brands, product and service providers. Currently this is achieved through different marketing and/or other programs. Brands, product and service providers attempt to connect with consumers through different channels: TV, radio, online advertising, etc. The consumers are bombarded every day with an enormous amount of information received from 3^{rd} parties. The consumers also make buying decisions based on such information. The growth of businesses is highly depended on the budget allocated to these efforts and most importantly on the efficiency and results of such efforts. The platform described in this invention creates a new avenue for brands, product and service provides to connect with consumers. This invention consists of creating a new avenue/platform to connect brands, product and services to consumers through consumers' known contacts in order to increase the return on their marketing efforts.

The Merchants are registered and create their profiles in a server. They create their marketing persona and provide details of preferable channels of communication. Merchants then find the best plan that fits their needs included by not limited to proprietary system features such as: marketing persona selection, individual marketer selection, audience selection, etc. Merchants either select the marketing content from a large catalogue of content or create their marketing content or a hybrid of both, and determine how many potential customers they want to reach, when they want to reach these potential customers and through what channels of communication do they want to reach the potential customers. The system will calculate the cost and charge merchants accordingly. The content created will be reviewed by moderators for compliance. Merchants will have access to a variety of choices and reports in order to improve the return on their marketing efforts over time.

Individuals will register and create their profiles and marketing personas. Their potential compensation will be calculated by number of contacts, breadth of channels, accuracy of contacts marketing information provided, continuous efforts to upgrade and improve their network, performance, etc.

Individuals will be assigned marketing content to distribute to their contact networks or will grant permission to have marketing content distributed to their contact networks via various channels. Individuals reserve the right to terminate participation in the program at any point in time. Once the content is distributed, the individual's account is credited based on a proprietary payment formula.

The main purpose of the software platform is to match the Merchant's content with the ideal target consumers in order to improve Merchant's business efforts. The proprietary algorithm will automatically analyze Merchants and Individuals input information and assign the content to consumers that best fit the criteria.

### EXPLANATIONS FOR DRAWING

The attached drawing was filed with the original application.

The drawing summarized the activity flow that connects merchant to users. Merchants will create content and will send that content to the server. The server will store merchants profiles, users profiles, marketing content, matching algorithms, etc. The content will be matched with users based on multiple criteria and the data will be pushed from server to an individual or a group of users. The users will publish/post or send the content to their respective networks via text, email, social platforms, etc. The server will monitor how users' networks will react or engage to the published/posted/sent content. Engagements include but are not limited to the number of opened emails, likes, forwards, comments, etc. The server will collect this information and will push it periodically to Brands in order to allow them to improve performance of their future marketing efforts.

1. The concept, method and/or technology that allows Individuals to participate in 3^{rd} party Merchants' programs (Merchants are unrelated to Individuals) for a remuneration;
The concept, method and/or technology that allows Individuals to treat their contact networks as assets and use such networks to generate income or other forms of remuneration.
The concept, method and/or technology that allows Individuals to distribute 3^{rd} party content to their contact networks on behalf of brands, products and service providers for a renumeration.
The concept, method and/or technology that allows/enables any Individual to market products and/or services on behalf of 3^{rd} party Merchants;
The concept, method and/or technology that allows/enables Merchants to reach a broad base of consumers through Individuals which are known to consumers through their contact networks.
The concept, method and/or technology that enables/allows Merchants to allow unknown Individuals to market on their behalf without having direct contact with each other.
The concept, method and/or technology that allows Merchants to select specific Individuals to market their products (influencer selection).
The concept, method and/or technology by which marketing profiles are created for consumers based on information received by one and/or more Individuals and/or self-provided information;
The concept, method and/or technology by which Merchants and Individuals are matched up based on their marketing profiles;
The concept, method and/or technology by which Merchants are guaranteed to reach a certain amount of potential customers at a pre-determined fixed price;
The concept, method and technology used to determine payments to Individuals for usage of their contact networks.
